(19) United States
(12) Patent Application Publication
(10) Pub. No.: US 2006/0111945 A1
(43) Pub. Date: May 25, 2006

(54) Method and system for tracking real estate transactions

(75) Inventors: Jeffrey Tinsley, Los Angeles, CA (US); Sean Whiteley, Los Angeles, CA (US); Jiayu Ye, Inglewood, CA (US); Kenneth Brotherton, La Crescenta, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: RealtyTracker LLC, Los Angeles, CA (US)

(21) Appl. No.: 10/994,128

(22) Filed: Nov. 19, 2004

(51) Int. Cl. G06Q 40/00

(52) U.S. Cl. 705/4; 705/39; 705/38

(57) ABSTRACT

A method and system is provided for tracking real estate transactions via the Internet and other networked devices. The method includes the steps of receiving and storing in a computerized database initial data inputs from buyers, sellers, and real estate agents and other vendors relating to identifiable pieces of real estate. In the next step, database files are established for these identifiable pieces of a transaction and these files are organized according to each contact. Throughout the transaction, information is continuously being received and stored into the database file from the contacts after a task is completed of the tasks required to be completed. As this information is received, the system calculates a contact progress and a buyer/seller progress and progress of the transaction is graphically communicated to the contacts in the form of a contact progress bar and a buyer/seller progress bar.

### FIELD OF THE INVENTION

The present invention relates to a method and system for tracking real estate transactions and more particularly for keeping all parties to the transaction updated on the progress of the transactions.

### BACKGROUND OF THE INVENTION

Computerized methods and systems are well known for managing real estate transactions. One such method and system includes receiving and storing data from a number of contacts including buyers and sellers of real estate, and vendors that are associated with various phases of a real estate transaction, accessing vendor data based upon the occurrence of a particular phase of the real estate transaction, and then communicating this vendor data to a buyer and/or the seller; see U.S. Pat. No. 6,321,202.

A typical real estate transaction often involves a buyer and a seller of an identifiable piece of real estate, a real estate agent or realtor, and numerous other vendors. The other vendors provide goods and services relating to real estate, such as, mortgage brokers, title company agents, insurance agents, appraisers, building inspectors, and contractors for house painting, plumbing, electrical work, roofing and the like. A prospective buyer or seller of real estate is faced with a multitude of choices in selecting from a number of prospective realtors and other vendors of a real estate transaction.

There is a need for a method and system for tracking each step of a real estate transaction, for selecting realtors and other vendors and for providing a more efficient means of communication between the buyer and seller as well as between all vendors.

### SUMMARY OF PREFERRED EMBODIMENTS OF THE INVENTION

The present invention is directed to a method and system for tracking real estate transactions via a computerized and interconnected communications network, e.g. the Internet. One preferred method includes the steps of receiving and storing in a computerized database initial data inputs from a plurality of contacts including buyers, sellers, and real estate agents and other vendors relating to each of a plurality of identifiable pieces of real estate. In the next step, a separate database file is established for each of these identifiable pieces of a real estate transaction and each of these files is organized according to each contact of the transaction. Throughout the entire transaction, information is continuously being received and stored into the database file from each of the contacts after at least one task is completed of the number of predetermined tasks required by each of the contacts to complete the transaction. As this information is received, the system calculates the contact progress of each of the contacts.

Contact Progress is defined herein as a percentage that is calculated by dividing the number of tasks completed by each of the separate contacts at any given time during the transaction by the total number of tasks required to be completed by that contact and multiplying the result by 100. In one embodiment of the present invention, the contact progress is graphically represented in the form of a bar and the resulting contact progress bar is communicated during the transaction. In another embodiment, the system of the present invention has the ability to communicate directly with existing legacy systems, database management systems, through a set of API (“Application Program Interface”) as described in greater detail below.

The total number of contacts or participants to the transaction is determined and constantly updated throughout the course of the transaction. In another embodiment of the present invention, the total number of contacts to a transaction at any given time is used to calculate a buyer/seller progress bar. The buyer/seller progress is defined as the percentage that is calculated by dividing the sum of all of the contact progress of the total number of contacts in the transaction divided by the total number of contacts in the transaction. The buyer/seller progress is graphically represented in the form of a bar and the resulting buyer/seller contact progress bar is communicated to the contacts involved in the transaction.

One preferred system for tracking real estate transactions via the Internet includes means for receiving and storing data inputs from all of the contacts relating to each of a plurality of identifiable pieces of real estate; means for establishing a separate database file for each identifiable piece of real estate of a given real estate transaction; means for organizing the data into separate files for each of the contacts of the real estate transactions; means for receiving and storing information from each of the contacts in the database file after at least one task is completed of the number of predetermined steps required by each of the contacts to complete the real estate transaction; means for calculating and graphically representing the contact progress bar and the buyer/seller progress bar for each of the contacts; and means for communicating the contact progress bar to all users of the system and the buyer/seller progress bar to all of the contacts involved in the transaction.

### BRIEF DESCRIPTION OF THE DRAWINGS

Further features and advantages will become apparent from the following and more particular description of the preferred embodiment of the invention, as illustrated in the accompanying drawings in which:

FIG. 1 is an overall schematic view of the system of one embodiment of the real estate tracking system of the present invention;

FIG. 2 is a view of a typical home Web page a user sees before initiating one embodiment of the present real estate tracking system;

FIG. 2A is a view of a typical Web page after a user clicks on the “Find an Agent” icon near the bottom of the home Web page shown in FIG. 2;

FIGS. 2B-2C are views of the sequential Web pages after a user clicks on the “MyTracker wizard” icon of shown in FIG. 2A to initiate the tracking process of one embodiment of the present real estate tracking system;

FIG. 3 is a view of a typical Web page after a user indicates the user's role in the transaction is that of a buyer in one embodiment of the present real estate tracking system;

FIG. 4 is a view of a typical Web page after a user indicates the user's role in the transaction is that of a seller in one embodiment of the present real estate tracking system;

FIG. 5 is a view of a typical Web page after the users indicate they are a buyer and a seller jointly seeking a realtor in one embodiment of the present real estate tracking system;

FIG. 6 is a view of a typical Web page after a user indicates the user's role in the transaction is that of a realtor in one embodiment of the present real estate tracking system;

FIG. 7 is a view of a typical Web page after a realtor proceeds with the tracking process of one embodiment of the present real estate tracking system referred to herein as My Tracker;

FIGS. 7A-7H illustrate an entire Web site navigation map of one embodiment of the present real estate tracking system;

FIG. 8 is a view of typical Web page after a buyer proceeds with the tracking process of one embodiment of the present real estate tracking system;

FIG. 9 is a view of a typical Web page after a realtor proceeds to view messages in the tracking process of one embodiment of the present real estate tracking system;

FIG. 10 is a view of a typical Web page after a realtor proceeds to view a summary of messages in the tracking process of one embodiment of the present real estate tracking system;

FIG. 11 is a view of a typical Web page after a realtor proceeds to post a message in the tracking process of one embodiment of the present real estate tracking system;

FIG. 12 is a view of a typical Web page after a buyer proceeds to view a summary of messages in the tracking process of one embodiment of the present real estate tracking system;

FIG. 13 is a table showing the actions taken by a typical user of the present real estate tracking system and the trigger events that result from such actions;

FIG. 14 shows a typical rating chart for users to fill out at the end of a transaction; and

FIG. 15 is a view of a typical Web page for a vendor to use to upgrade an account in one embodiment of the present real estate tracking system.

### DETAILED DESCRIPTION OF PREFERRED EMBODIMENTS OF THE PRESENT INVENTION

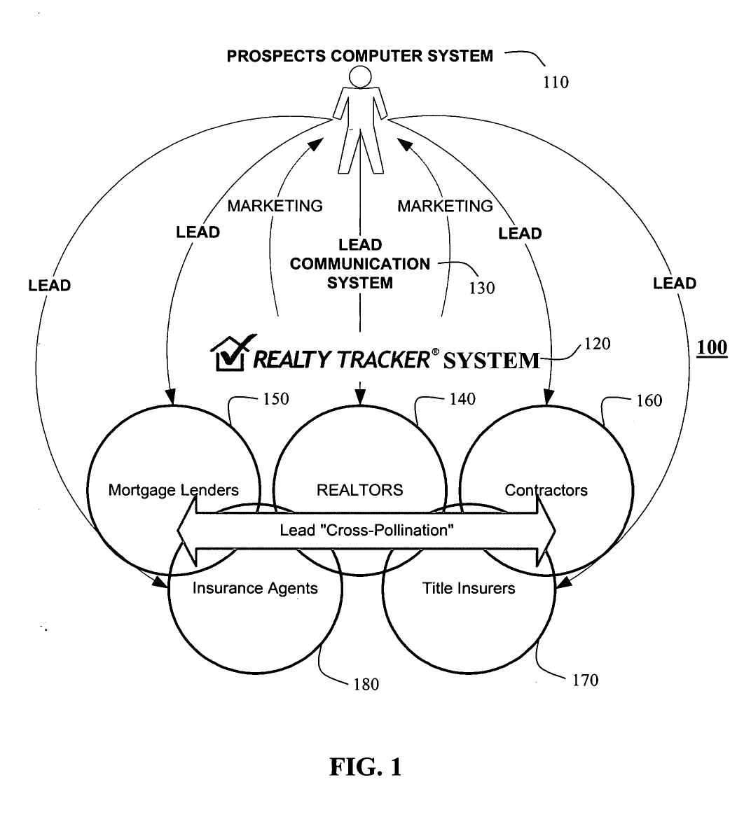

Referring to FIG. 1, a schematic view of real estate tracking system 100 is shown. A prospect goes on-line using a typical computer system 110 to provide the initial information in carrying out the method of the present invention. The prospect can be a buyer, a seller, or a buyer and seller that is seeking a realtor for an identifiable piece of real property.

The standalone computer system 110 of any prospect is operably connected to a controlling central computer system 120 through modem 130 or any other suitable remote communication system. Computer system 110 is typically in the user's home. However, alternate remote sites can be made available for any user wishing to be a participant in the real estate tracking method. The controlling computer system 130 contains the software to carry out the real estate tracking method of the present embodiment. The user interacts with the real estate tracking system's Web (World Wide Web) site by using any of a number of standard Web browsers such as Netscape Navigator® and Microsoft Internet Explorer®. Users will also be able to interact with the present tracking system using standard mobile devices to obtain progress of their transactions, receive mobile alerts, and communicate directly with the system.

In a similar manner, realtors computer system 140 and various vendors, i.e., mortgage lenders system 150, contractors system 160, title insurers system 170, and insurance agents system 180 communicate through modems (not shown) to central computer database management systems 120, as well as to prospect's computer system 110. Other vendors including escrow agents communicate using similar systems through a set of API to system 120

Once the prospect has agreed upon a realtor, a separate file is established in the database of the central computer system 120 for that particular piece of real estate. Within the file, a sub file is maintained for each contact to central computer system 120.

A portion of the software program of the present tracking system carries out the steps of calculating the contact progress for each of the contacts and for calculating the buyer/seller progress bar. Specifically, computer system 120 contains sufficient storage space on a hard drive or a plurality of hard drives for storage of the software programs for running all of the steps of the real estate tracking method, for storing the data and other information inputted from various prospects in separate files according to a particular piece of real estate, and for evaluating the information received from the users and calculating the contact and buyer/seller progress bars. Computer system 120 is generally remotely located at an office (not shown). It is not critical that prospect's system 110 and central computer system 120 be the same type of system and any system known by those skilled in the art such as Macintosh, PC, UNIX system, VAX, and others can be used.

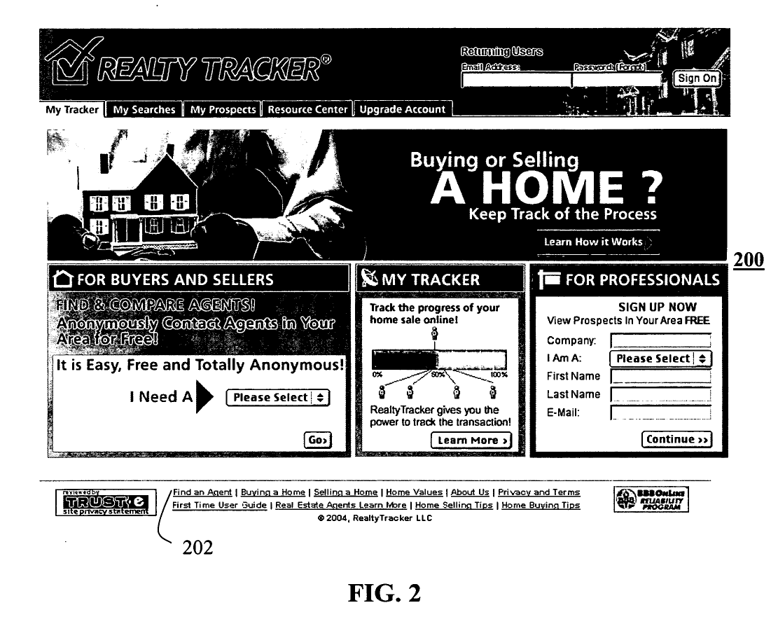

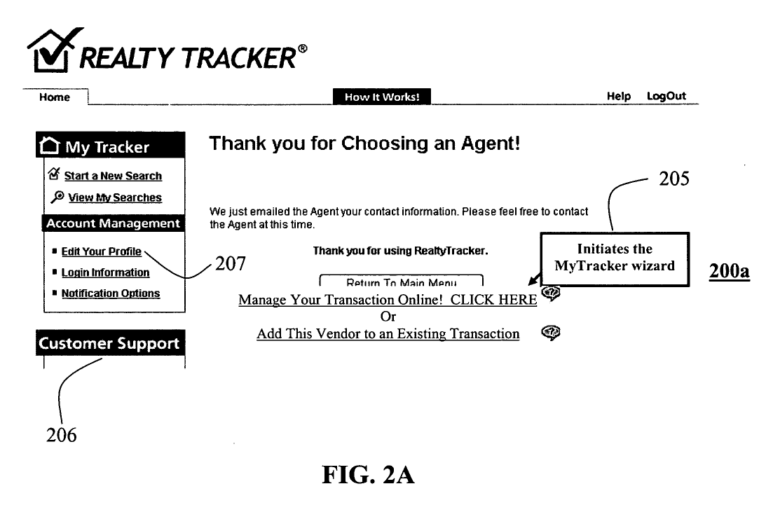

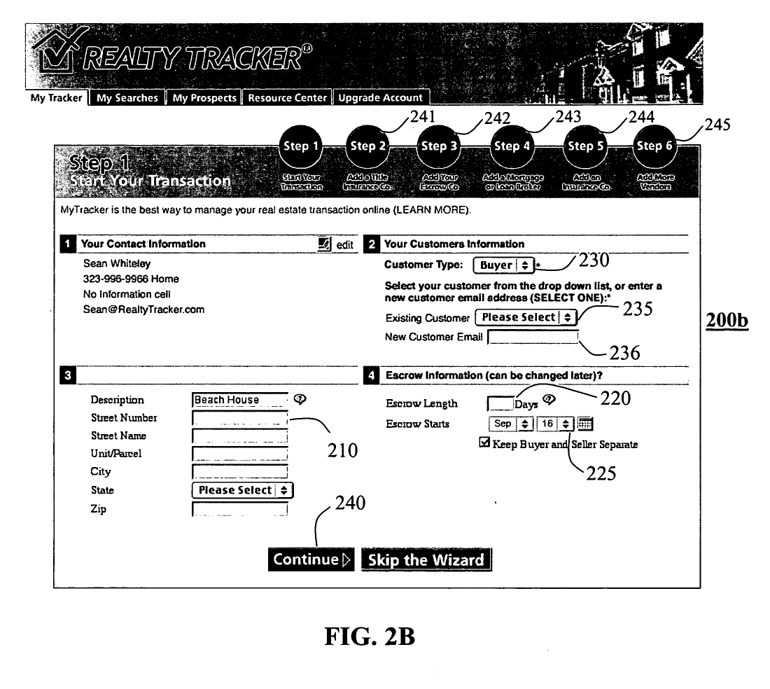

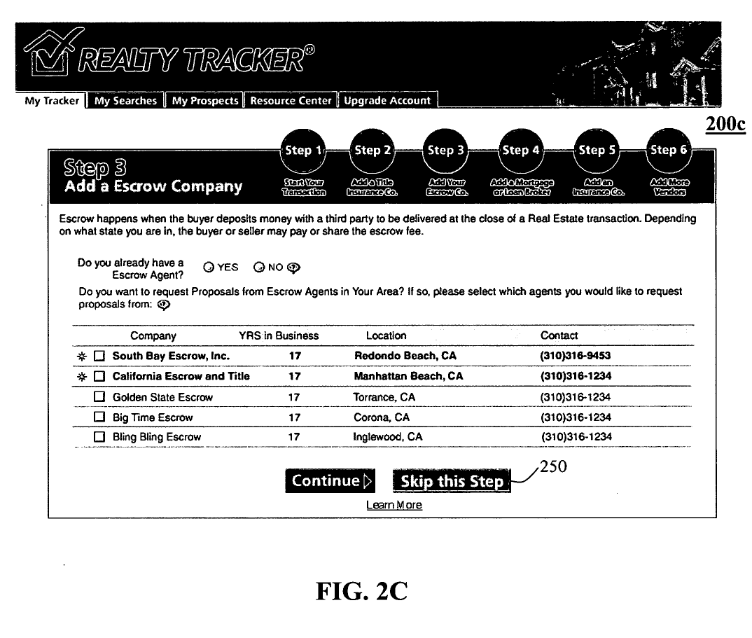

FIG. 2 shows a typical home Web page 200 for one embodiment of the real estate tracking system of the present invention that a prospect views on computer 110. The prospect points to “Find an Agent” icon 202, one often icons at the bottom of home Web page 200 and each of the other Web pages of the real estate tracking system. After a series of clicks in the standard method of navigating the Web, the prospect is directed to Web page 200a that contains the information shown in FIG. 2A. In addition, the user clicks box 206 for customer support or box 207 to edit the user's profile, described in detail below.

The user of the system has the option of initiating the tracking method of the preferred embodiment of the present invention by clicking on My Tracker wizard icon 205 that directs the user to Web page 200b having the content shown in FIG. 2B. However, until the prospect has selected an agent that, in the case of a buyer, has listed the home or other property of interest, the real estate transaction to be tracked in accordance with the method of the preferred embodiment of the present invention has not begun. Similarly in the case of the seller, a transaction has started when the seller's search for a realtor is successful and the realtor agrees to list the seller's property.

After a buyer has selected a realtor, the next step is to begin the transaction by filling in data in a series of box such as box 210 shown in FIG. 2B with the property address; this is the identifiable piece of real estate that is listed by the realtor and that is tracked throughout the period of the transaction. To the extent the information is known, boxes 220 and 225 are to be filled in with the length of escrow in days and the date for the start of escrow. Within box 230, the user is taken via a typical drop-down feature to the appropriate Web page to enter the necessary data as to the user's type. The drop-down choices of types of customers that become visible in box 230 include, but is not limited to, buyer, seller, agent, mortgage broker, appraiser, insurance company, inspector, title/escrow companies, contractor and other vendors. If the choice is “other,” the user fills in an appropriate box with the specific service to be provided by the vendor to the transaction. Box 235 is used for an existing customer and box 236 is used to fill in an e-mail address for a new customer. The user clicks box 240 to continue to the next step of the tracking process that includes possibly adding a title insurance company in step 2, an escrow company in step 3, a mortgage or loan broker in step 4, an insurance company in step 5 or other vendors in step 6 shown in the respective circles 241-245. For example if the user has clicked on box 240, a Web page to select a title insurance company appears. In the event in this particular example, the user does not need a title insurance company, the user clicks a “Skip this Step” box similar to box 250 shown on FIG. 2C and Web page 200c appears for the user to select an escrow agent.

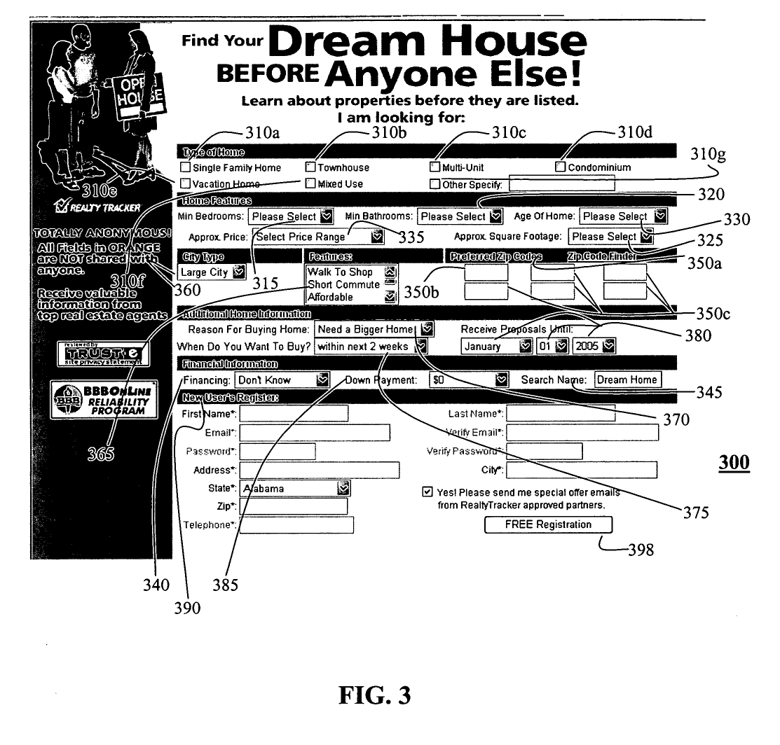

If the user clicks on buyer in box 230 of FIG. 2B without providing the address of property to be tracked, the user is directed to Web page 300 shown in FIG. 3. In this case, the buyer is requested to input into the real estate tracking system information on the home for which that buyer is searching. This information includes, but is not limited to, the type of property or home, the minimum number of bedrooms, the minimum number of bathrooms, the approximate square footage of the home, the age of the home, the desired price of the home, the location of the home by ZIP code, the buyer's mortgage status, and the identity or name of the search for the home, e.g. “dream home,” “vacation home”, and other names to identify the real estate involved in the transaction.

For example, the information is inputted into the real estate tracking system by clicking one of boxes 310a-310g for the property type, and by respectively clicking the chevron to the right of the boxes 315, 320, 325, 330, 335, 340 and 345 shown in FIG. 3 and filling in the appropriate answer that appears in the respective pop-up screen for the minimum number of bedrooms and bathrooms, square footage, the age, the desired price, the buyer's financing status, and the name of the search. The ZIP code of the home can either be found by clicking the ZIP Code Finder icon 350a and/or filling the buyer's first choice of ZIP code in box 350b or subsequent ZIP code choices in boxes 350c.

Additional information inputted by the buyer includes the type of location for the home by respectively by the buyer clicking on box 360 that includes a drop-down box to select from a city, suburban, small city or rural location. The particular features of the location of the home are indicated by the buyer clicking on box 365. Examples include whether the home is located only a walk away from shopping or is a short commute to the city as shown in FIG. 3. Other required information is inputted by respectively clicking the chevron in the boxes to the right of boxes 370, 375, 380 and 385, for reason for buying the home, the approximate time for the sale to be completed, the approximate date for all proposals to be sent to the buyer, and the amount of down payment information.

After the required information has been inputted, the buyer inputs indentity data in the new register box 390. The required information includes the name of the buyer, address, e-mail address, phone and fax numbers, and the selection of a password to permit the returning users to maintain anonymity. Once the required information is inputted, the buyer clicks box 398 to obtain a free registration for access to the real estate tracking system.

When the buyer completes this stage of the process, the tracking system recognizes an automated trigger event has occurred. The tracking system will initiate anonymous searches for a realtor on the user's behalf as well as sending the same lead to a mortgage broker to secure a loan for the buyer.

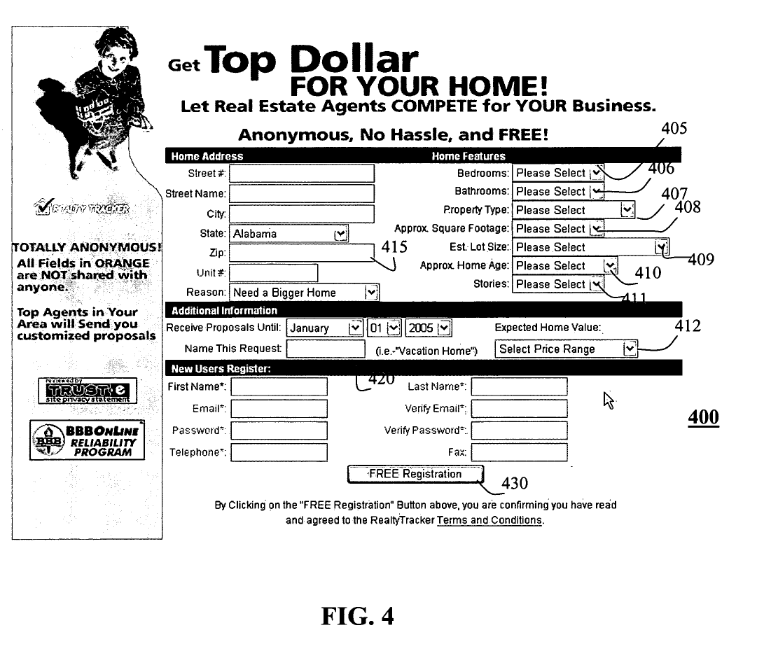

If the prospect clicks on as a seller in box 230 in FIG. 2B, the user is directed to a typical Web page 400 shown in FIG. 4 where the seller is directed to input into the real estate tracking system information on the home that is being sold. In a similar manner to that used by the buyer to initiate an anonymous search for a realtor, the seller respectively clicks the chevron to the right of the boxes 405-411 and fills in the appropriate answer that appears in the drop-down screen for the number of bedrooms and bathroom, property type, approximate square footage, estimated lot size, age of the home, number of stories, and expected price for the home.

The additional information that is required to be inputted by the seller includes the exact location of the home including ZIP code in box 415; the name of the request for home selling services, e.g. permanent residence or vacation home, in box 420; the name of the seller, e-mail address, phone and fax numbers, and a password in the subsequent boxes as shown in FIG. 4. After the required information is inputted into the system, the seller clicks box 430 to obtain a free registration for the real estate tracking system.

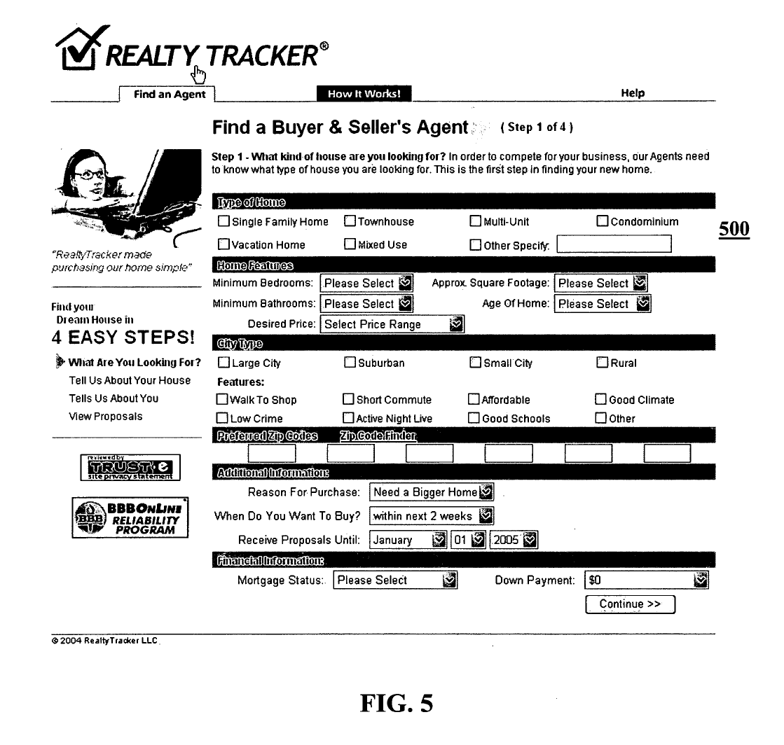

If a buyer and a seller are jointly seeking a realtor and/or other vendors to handle a real estate transaction that they tentatively agreed upon, they click on both the buyer and seller icons in box 230 of FIG. 2B that directs them to the typical Web page 500 shown in FIG. 5. In this case, the buyer and seller each supply the same type of information on Web page 500 as the information discussed in connection with FIGS. 3 and 4 for the buyer and seller.

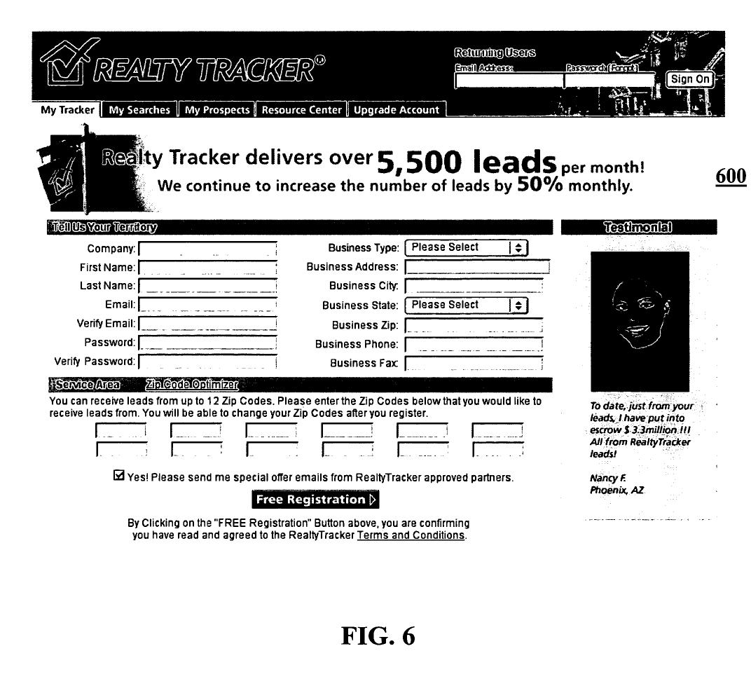

FIG. 6 shows a typical Web page 600 of the on-line forms that a realtor fills out to be included in the database of realtors that are among those that could be included as a match for a particular search initiated by a buyer or seller. Web page 600, also referred to herein as the Professional Registration page, includes, but is not limited to, boxes for the required system registration information including the name and address of the real estate agent, the name of the individual realtor, the e-mail address, phone and fax numbers, and the selection of a password. In addition, the user is required to fill in the appropriate box with at least one ZIP code of the property for which the agent would like to receive prospects. Once the forms have been filled out, the realtor clicks on the “Free Registration” icon that confirms the realtor has read the terms and conditions of the tracking system that requires a monthly fee to obtain leads to prospects.

The real estate tracking system processes the search of, for example, the buyer and provides the registered buyer with a list of agents from the database of registered realtors that has within its inventory of real estate a property that matches the search criteria that had been requested. The tracking system gives each the property within its database a transaction number and begins to track the property during the transaction process until the transaction has been completed with the close of escrow.

The tracking system creates a virtual transaction dashboard to enable all of the parties to the transaction to effectively manage each step of the transaction. The system of the present differentiates each user by the user's role in the transaction. Each separately numbered transaction is the focal point that ties each party together throughout the transaction. The system uses a combination of checklists, message boards, contact progress bars, and notification e-mails to help keep all users of the system updated on the status of the transaction. The tracking system creates a collaborative environment where all users as well as the parties in the real estate transaction can more easily communicate to track the progress toward the sale or purchase of a home or other piece of real estate.

In one embodiment of the invention, anyone, including all vendors, may use the present tracking system and the first transaction is without obligation or fee. Users joining a transaction must first register for a free account having the following benefits: (1) view all prospects in the area of the real estate of interest without paying a fee; and (2) view any transactions to which they are invited. However vendors must pay to send proposals to prospects regardless of whether they have a free account with the tracking system. A user must be either a paying member of a prospect to initiate a transaction. Any user may invite others to join in a particular transaction, which makes the present system viral. However, only the user that has started the transaction on a given property can add and subtract vendors.

Each time a vendor is invited to participate by a prospect, one of the following actions will take place: (2) the vendor automatically joins a transaction if it is started based on a successful realtor search by a prospect; and (2) both the prospect and the vendor will have the option to start the transaction if one has not as yet begun. The transaction starts when both the prospect and the vendor have been invited to participate and they accept this invitation. For any given transaction initiated through the present tracking system, all of the vendors providing a service to the transaction are added to the vendors' list.

The vendors use the Web site address of the system, such as “RealtyTracker.com”, without obligation and are free to browse through the Web pages of the system to determine if any of the transactions has any use for the services being offered by that particular vendor. If the vendor wishes to offer the vendors services in connection with a particular transaction, the vendor registers and pays a monthly fee to start the transaction and to obtain leads to prospects in the same manner as indicated above relating to a realtor. When a buyer selects that particular vendor, the vendor will be invited to join the transaction. Once the vendor completes part or all of the related services for that transaction, e.g., a title company provides title search and insures title, the vendor updates that action or participation status related to that transaction. All of the other parties in the transaction are informed about this update will receive e-mail notification. Registered vendors access the Web page at any time to view the updated “Status” for each area or vendor related to that transaction. For example, a registered buyer can determine if the title insurance process is complete and obtain additional related information from the title company.

In a typical transaction, after the buyer has supplied the necessary information to become a registered buyer and has used the tracking system at, for example, RealtyTracker.com, to find a realtor, the buyer can complete the first step in the transaction by identifying the property of a particular seller. At this point the buyer can add the various other vendors to the transaction. As a second step in the transaction, the buyer may choose to invite a title insurance company to send a proposal for providing insurance to protect the lender, based on the lender's policy or the buyer based on owner's policy, against loss arising from disputes over ownership of a property. However, no step of the process is mutually exclusive. A buyer may add multiple vendors of the same type and send the same type of service out to bid.

Once the buyer becomes registered and accepts an offer to purchase a seller's home, the buyer uses the virtual dashboard to manage the entire transaction of purchasing the home. The buyer will use the virtual dashboard to see the progress of each step of transaction as well as to view messages from the various vendors involved in the transaction. The buyer may accept offers of registered vendors or has the option of finding new vendors not presently in the tracking system of the preferred embodiment of the present invention and adding them to the transaction. All parties or contacts to the transaction are kept up-to-date by notification e-mails and can see when other parties have read a message. The system also recognizes when an e-mail bounces and transmits a notice to the contacts of the transaction that the invited vendor did not receive the e-mail.

An example of the use of the foregoing virtual dashboard and subsequent notification takes place during that part of the transaction in which the realtor has inspection reports on that home and sends them to the seller for review. The realtor knows that once the inspection documents are sent half of the job is done and the realtor logs that fact into the real estate tracking system and updates the contact progress on the virtual dashboard to 50% done. The realtor then leaves a message for the buyer that the inspection documents have been sent to the seller and the seller has 10 days for a response. The system automatically leaves a time/date stamp as to when the message has been sent and e-mails all vendors party to the transaction.

Each time a user selects one of vendors that has registered with the tracking system and paid the registration fee, that part of the process is considered to be completed or tracked. This will give the user positive reinforcement and serve as a trigger event for the next step in the process. Users will be able to start a transaction whether the initial search was to find a realtor or other vendor such as a mortgage broker or an insurance company to insure the property against fire, flood, earthquake or other loss. Any prospect can start a transaction even if a search for a vendor on the site has not been done. One advantage of the real estate tracking system of the preferred embodiment of the present invention is that realtors are more disposed to register and begin a transaction to sell or buy a given piece of property to a respective registered buyer or seller for their clients if they think it will make their job easier by lowering call volume and will enable them to keep their clients better and more easily informed.

Each user-initiated search is unique and placed in a separate computerized file or sub file that can include one or more vendors. The user will be able to add vendors themselves, start an anonymous search for other vendors, or select one of system's registered vendors. The vendors that are the result of a specific search will be able to work with one another once the user selects them as vendors. At that stage, each of the vendors can find the identity of other vendors and have a central location where they can communicate with one another.

After a user registers, the real estate tracking system of the preferred embodiment of the present invention initiates an anonymous search based on the triggering action of the registration. For example, if a prospect signs up to find a realtor, this triggering event sends a lead not only to a registered realtor, but also sends a lead to a registered mortgage company. Therefore, another advantage of the system is the so-called multiplier effect of one lead and communicating to several different vendors that can supply various services to the transaction. The users to this system remain anonymous to the vendors, because the vendors only need the ability to see data points of a given transaction and not the actual identity of the buyer or seller. The system accentuates these anonymous leads of buyers and sellers by distributing the data of any transaction to vendors to a provide users with variety of additional services. Vendors find the use of the virtual dashboard of the tracking process to be such an advantageous method for handling real estate transaction that the vendors will introduce new prospects into the system and thus create a viral marketing effect. Therefore, it is apparent the registered vendor can initiate other transactions. Depending on the particular fact situation, a mortgage broker to the transaction may also be a prospective seller, a realtor, or all of the above.

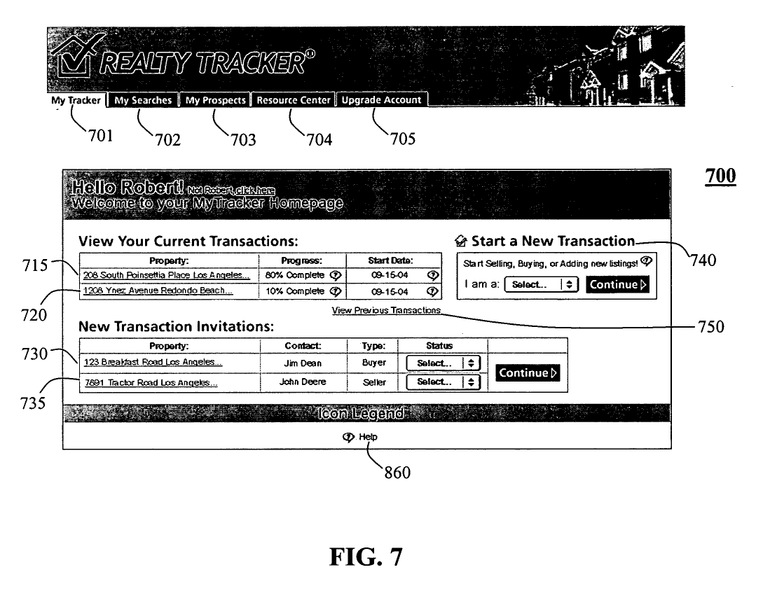

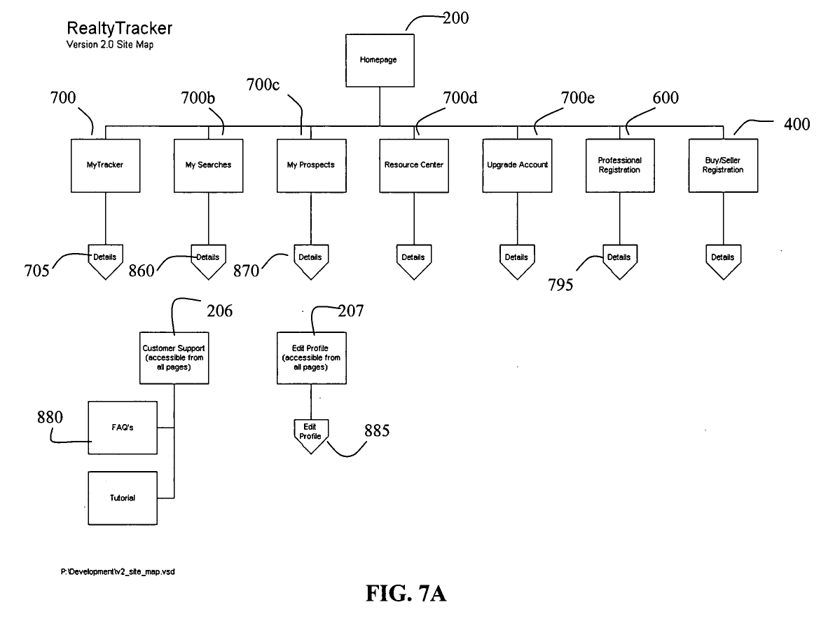

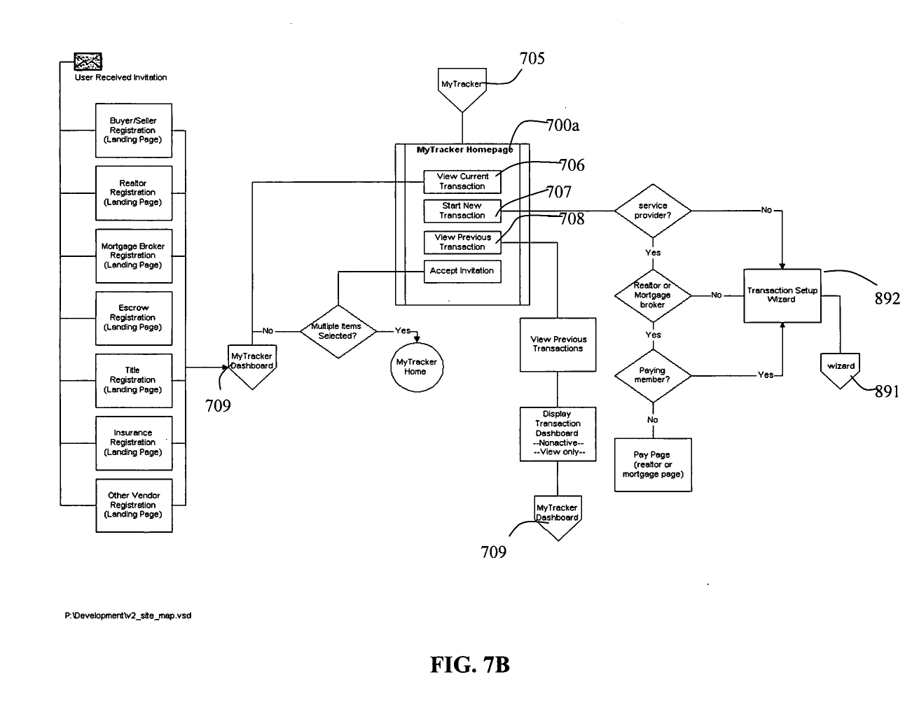

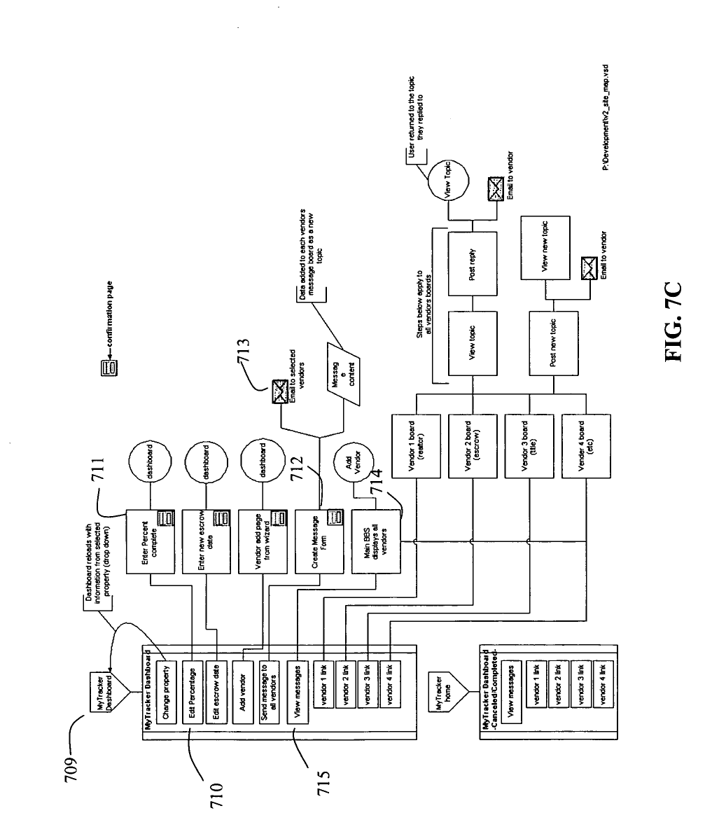

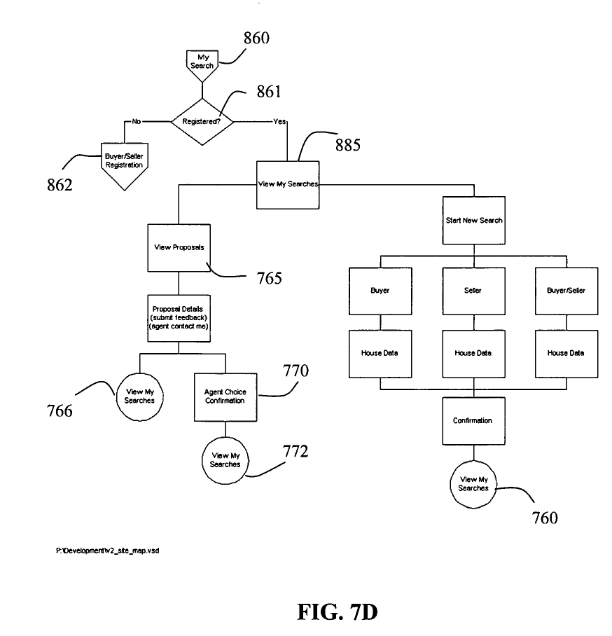

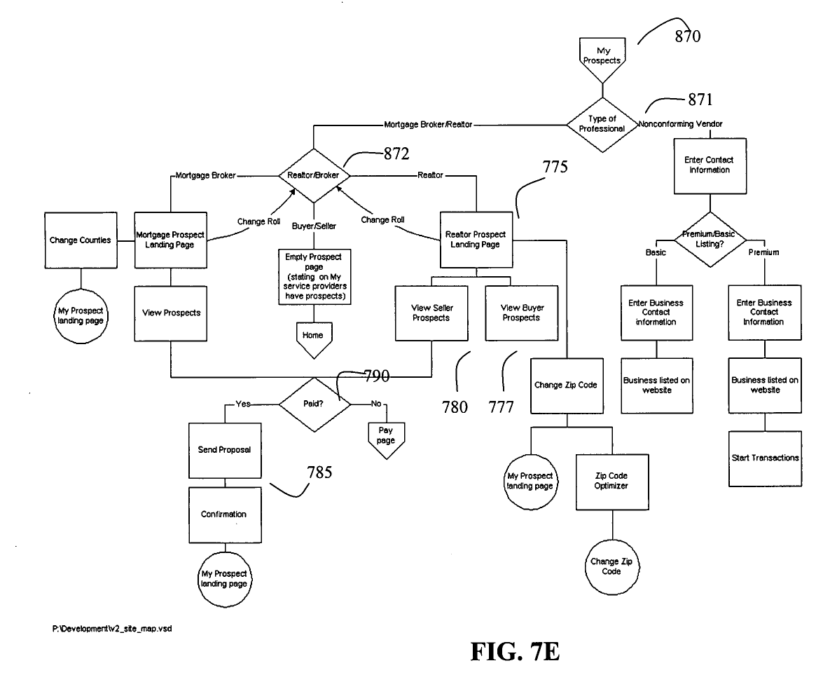

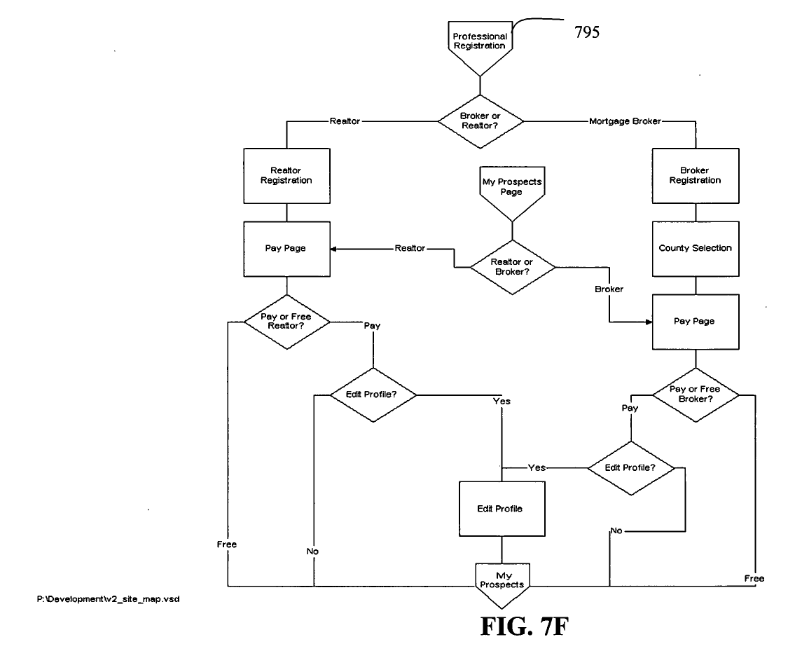

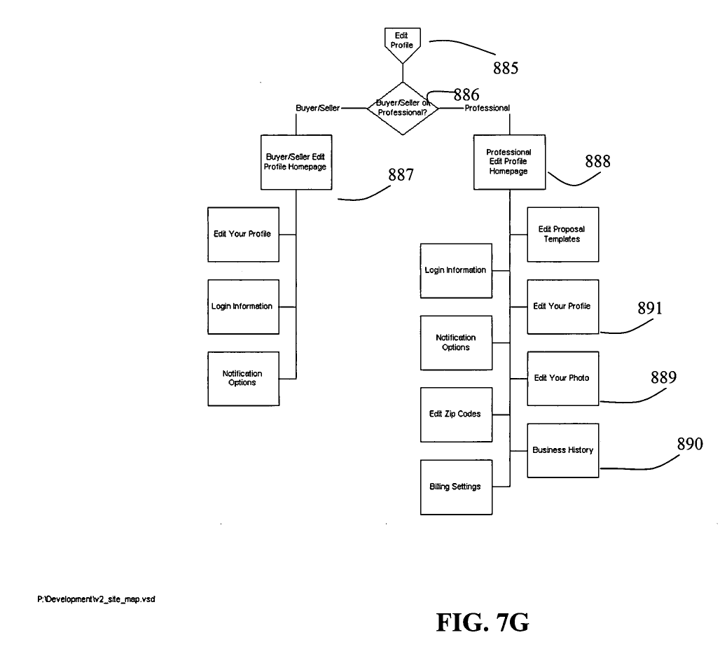

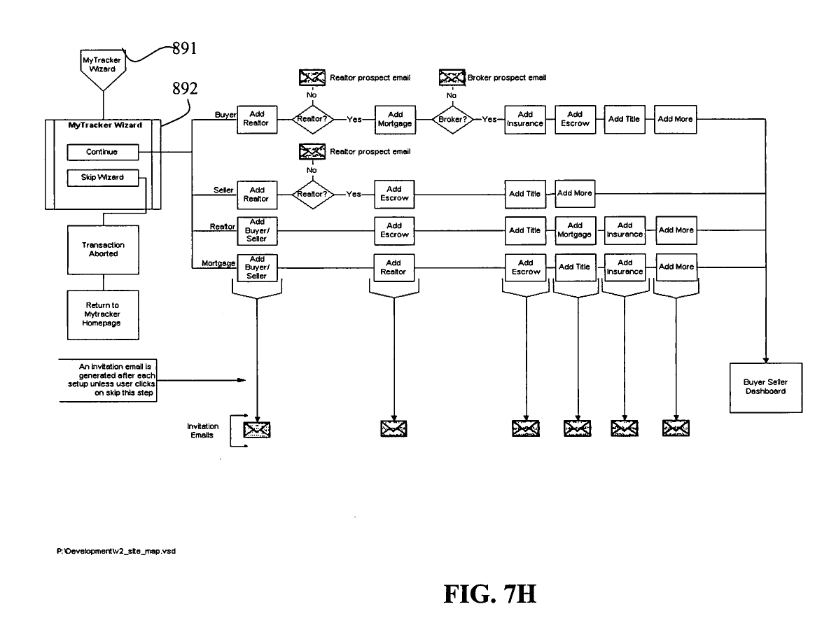

Since all of the users of the system, e.g., the buyers, sellers, realtors and other vendors, are so varied, the system is designed to process the varied information through the use of Web site navigation tools, e.g. graphic user interfaces (GUI) that are transparent to the user. The user is directed from the real estate tracking system home page shown in FIG. 2 to the “MyTracker” home page shown in FIG. 7 as page 700. The system uses a tab system of five tabs 701-705 to forward the user to the appropriate Web page as the primary navigation tool throughout the different screens of the tracking system of the preferred embodiment of the present invention. A user is returned to Web page 700 on clicking tab 701 when the user is viewing the other Web pages as a result of clicking tabs 702-705.

FIG. 7 shows the tracking of two current properties of a particular realtor named “Robert.” For example, one of the Robert properties is at 208 South Poinsettias Place, Los Angeles identified in box 715 and the other is at 1208 Ynez Avenue, Redondo Beach identified in box 720. Robert is also invited to add his name to an invitation to enter a new transaction at 123 Breakfast Road, Los Angeles, box 730 and 7891 Tractor Road, Los Angeles, box 735. On viewing this homepage, the user may click on boxes 715, 720 or 730 to be linked to transaction dashboard of each of the currently listed properties or of the new transaction, if that user is personally involved in that particular transaction and has entered the appropriate password. By clicking on the “Start a New Transaction” box 740, the user is linked to a new My Tracker homepage similar to that shown in FIG. 7, a page that all users are permitted to view. Finally, clicking on box 750 links the user to a previous transaction dashboard.

FIGS. 7A-H are standard block flow charts understandable by all those skilled in the art. These flow charts show various algorithmic paths and the Web site navigation map for all of the operations performed by the users and the computer system 120 of the present tracking system.

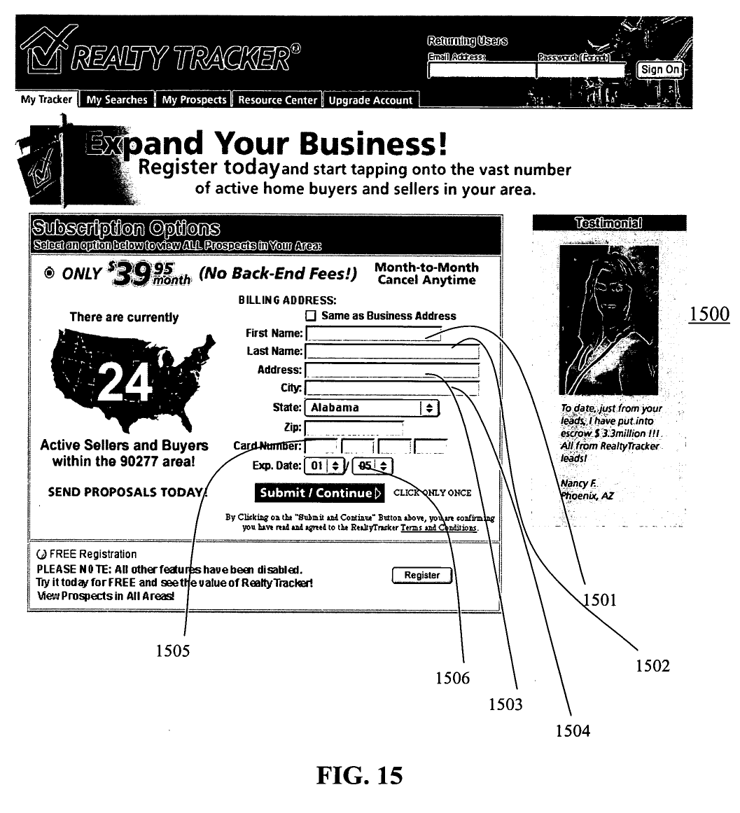

Specifically, FIG. 7A shows flow chart representing the sequential Web pages a user sees starting with block 200 for Realty Tracker home page 200 shown in FIG. 2, and continuing with block 700 for My Tracker Web home page 700 shown in FIG. 7, block 700b for the My Searches page, block 700c for the My Prospects page, block 700d for the Resource Center page, block 700e for the Upgrade Account page shown on FIG. 15, block 600 for Professional Registration page 600 shown on FIG. 6 and block 400 for Buyer/Seller Registration page 400 shown on FIG. 4. FIG. 7A also includes in the flow chart, block 206 for the Customer Support icon 206 and block 207 for the Edit Profile icon 207 shown on FIG. 2A. The Customer Support icon, also called the help iocn is preferably available on all Web pages of the system.

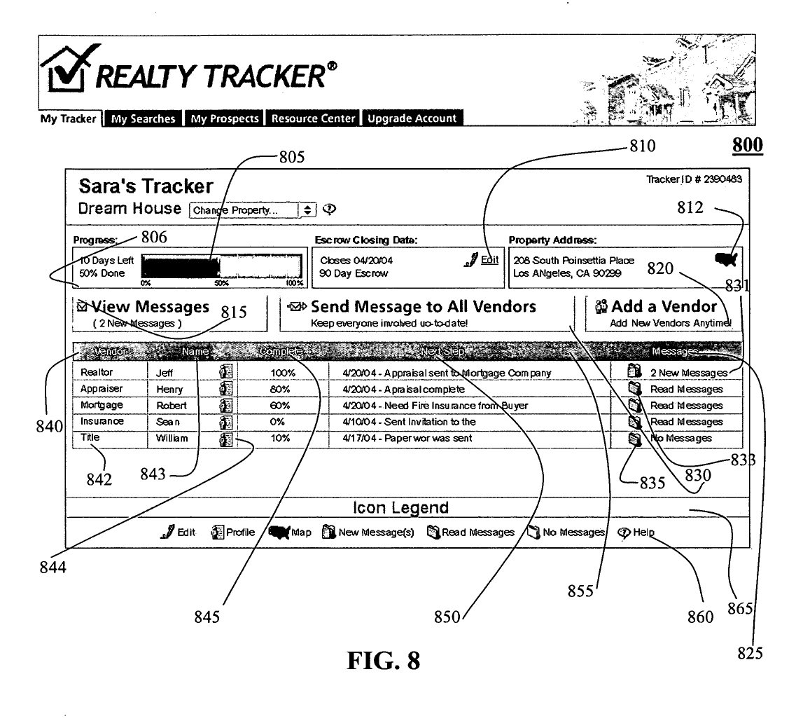

FIG. 7B shows the flow chart for the details of the My Tracker page 700 shown in FIG. 7 represented by block 705 under block 700 in FIG. 7A. Page 700 of FIG. 7 is the user's My Tracker homepage, personal dashboard, and communication center. From this page, the users can view on separate Web pages of their bids, proposals, and all transactions including current, new and previous transactions. The latter three Web pages are represented by blocks 706-708, respectively within the block representing page 700 in FIG. 7B. If the user clicks View Current Transactions icon 715 of FIG. 7 relating to one of realtor Robert's properties at 208 South Poinsettias, the user is directed to Web page 800, the personal dashboard of “Sara,” the buyer of that property shown in FIGS. 8. This is represented in FIG. 7B by My Tracker Dashboard block 709. Although, page 700 is visible to all users, the sequential screen displays are limited to show only the individual transactions the users are personally involved in.

FIG. 7C shows the flow chart for the details of My Tracker dashboard page 800 shown in FIG. 8 represented by blocks 709 shown in FIG. 7B. Page 800 is the transaction dashboard Sara views on the monitor of her computer system 110 for this specific property that is being handled by realtor “Jeff,” appraiser “Henry,” mortgage broker Robert, insurance agent “Sean,” and title insurance broker “William.” Progress bar 805 within box 806 graphically shows that 50% of overall progress by all contacts to the Poinsettia Place transaction has been completed, i.e., the buyer/seller progress bar. “Edit Percentage” block 710 and “enter percent complete” block 711 of FIG. 7C represent the calculation steps to determine the percentage graphically shown by progress bar 805. Box 806 also shows that 50% of the tasks are complete and that 10 days remain before the transaction is estimated to be complete. Progress bar 805 is the same for both the buyer and the seller and is simply the graphical image that changes based on the percentage of the tasks that are complete. Although, the progress bar looks the same, the actual percentage complete would be different for the buyer and seller if they were involved in the same transaction. A buyer and seller cannot be involved in the same transaction using the My Tracker system. This is the case since the buyer and seller normally do not have the same vendors. The buyer/seller progress bar is the mathematical average of all the other progress bars as discussed in detail below. The 90 day escrow period is shown to close on Apr. 20, 2004. This date can be edited by clicking on edit icon 810. A user can view the Poinsettia Place property by clicking on map icon 812. In one embodiment of the present invention, the user can also obtain a virtual reality tour of each room of the home being offered for sale as well as a tour of the grounds. This is accomplished by receiving the virtual reality tour data from a Multiple ListingService for that particular property. The user may also view the two new messages relating to this property by clicking box 815.

A vendor can be invited to join the list of approved vendors or place a bid for services for this property if a contact of the transaction clicks box 820 on any of the transaction dashboard pages, exemplified by page 800. A user has the option of creating and sending the same message to all of the vendors by clicking box 830 and thereby updating all of the vendors that are involved in the transaction. FIG. 7C represents this in “Create Message form” block 712 and “email to selected vendors” block 713. Alternatively, a user can either read any of the new messages sent to a vendor by clicking on the new message icon 815 or send a separate message to any of the vendors by clicking the read messages icon 833 or the no messages icon 835. “Main BBS” (bulletin board system) block 714 and “view messages” block 715 of FIG. 7C represent these steps of the operation. The foregoing demonstrates how a single transaction might add five to ten more vendors to the system of the preferred embodiment of the present invention than would not have otherwise heard about the transaction.

“Vendor” column 840 of table 842 of FIG. 8 is a scroll down list of all the vendors that are involved in the transaction. “Name” column 843 is a list of the names of the vendors. Column 840 contains all of the vendors involved in the transaction and Web page 800 only shows five of the six vendors involved in this particular transaction, i.e., the realtor, appraiser, mortgage broker, insurance agent, and title insurance company. The escrow company that holds the buyer's deposit until the close of the transaction is currently off the Web page because the company has not been invited to join the transaction yet. A transaction could have only one vendor, as adding multiple vendors is not a requirement. However, adding vendors is encouraged to increase the reach of the present system.

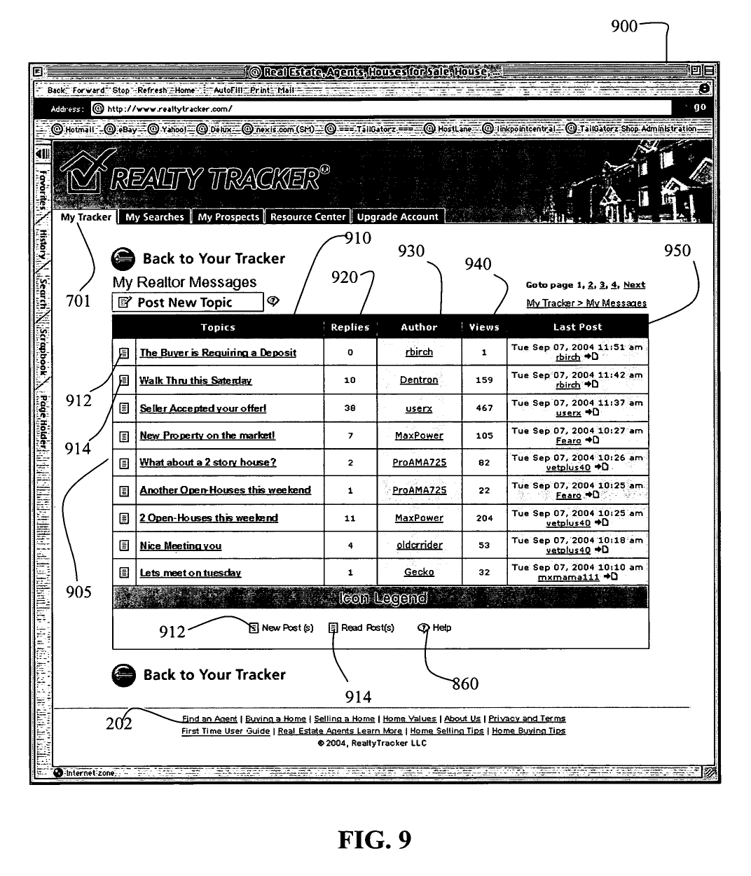

A user can click on profile icon 844 opposite the name of the vendor to obtain pertinent information on each of the vendors. “Complete” Column 845 indicates the percentage of vendor's tasks that have been completed. “Next step” column 850 also called the “last message” column shows a truncated version of the last message posted by a particular member of the transaction. “Messages” column 825 lists the new messages icon 831, the read messages icon 833 and no messages icon 835 that links the user to various messages Web pages. The new messages left for that particular vendor are retrieved by clicking icon 831. A message may be posted for the vendor by clicking icon 833. Icon 835 indicates no messages have been posted at the time the user is viewing Web page 800. A more detailed discussion of messages Web pages is given below in connection with FIGS. 9-12 below.

Help icon 860 that is shown in the “Icon Legend” bar 865 of Web page 800 as well as in the Web pages shown in FIGS. 7, 9 and 12 directs the user to answers to the most frequently asked questions (FAQ) by previous users after spending time browsing through the Web pages of the tracking system of the preferred embodiment of the present invention. This is represented in FIG. 7A by “customer support” block 206 and “FAQ's” block 880.

Column 845 sets forth, the contact progress, i.e., the percentage of the individual tasks or steps required to be completed by each of contacts during the transaction. This may be done by a manual process when posting a message or by some predetermined API method. In some cases, only the escrow company will determine how far along the transaction is complete. The contact progress for a first contact, P_{C1}, can be represented by the following equation:

$${P}_{C1} = \frac{{x}_{1}}{{n}_{1}} ( 100 )$$

where:
x₁=the number of tasks completed by a first contact at any given time during the transaction, and
n₁=the number of predetermined tasks required to be completed by the first contact.

Contact progress bar 805 on transaction dashboard page 800 for the buyer is graphically represented as 50%. This does not mean that the buyer has completed 50% of the tasks. The buyer/seller progress bar 805 is graphically represented as 50% because it is calculated by taking the sum of all of the individual contact progress of the vendors and dividing the sum by the total number of contacts. It can be calculated by using the following equation:

$${P}_{B / S} = \frac{\sum ( {PC}_{1} … PCy )}{y} ; and$$

where:
y=the total number of contacts to a given transaction; and
PCy=the percentage of the tasks completed by the last or y^{th} contact to the transaction.

The above calculation is illustrated by taking the values listed in column 845 in FIG. 8, i.e. 100% for the realtor, 80% for the appraiser, 60% for the mortgage broker, 0% for the insurance agent, and 10% for the title company agent. The sum of all these percentages equals 250%. The total number of contacts is 5. Therefore, the buyer/seller progress bar (P_{B/S}) equals 50%.

In another embodiment of the present invention, the system has the ability to communicate directly with existing legacy systems, database management systems, through a set of API (“Application Program Interface”). The information will be interpreted so the progress bar will display a real-time status of the progress of the transaction. Each embodiment is not mutually exclusive, only the calculation method changes when API are used. The calculation method will be determined when the legacy system is setup to work with Contact Progress so as each milestone is passed, the percentage for that particular contact progress will change. There is an additional embodiment where the Contact Progress is solely determined by the escrow progress. The calculation method will be determined when the escrow system is setup to work with Contact Progress so as each milestone is passed, the percentage for entire transaction will change.

In this example shown in FIG. 8, the seller has not been included in column 840. This typical transaction is specifically for the buyer, the seller's progress is not included when progress is calculated manually. When the buyer and seller are working with an escrow company that is using the API of the present system, the buyer/seller progress bar, (P_{B/S}), is the same for both the buyer and the seller because it is calculated automatically through the predefined escrow process.

FIG. 7D shows the flow chart for the details of the My Searches page (not shown) represented by block 860 under block 700b representing the “My Searches” page that is accessed after the user clicks tab 702 shown in FIG. 7. “Registered” block 861 represents the algorithmic path to determine whether the user is registered. If not, the user is directed to “buyer/seller registration” page represented by block 862 of that name. If the user is registered the user is directed to the “view my searches” page represented block by that name. The My Searches page accommodates the different types of searches conducted by the system, i.e., finding a realtor, finding a mortgage through a mortgage broker, or finding a contractor, and permits the user to manage any of these types of searches. A user will be able to view and manage all searches and proposals from a single screen that will allow the user to drop down to view the searches screen represented by the “view my searches” block 760 or to the view proposals from the other vendors on a screen represented by the “view proposals” block 765 and “view my searches” block 766 in FIG. 7D. Once a search has been completed or a proposal is received, the user drops down to choose the vendor page represented by the “agent choice confirmation” block 770 and “view my searches” block 772 in FIG. D.

FIG. 7E shows the flow chart for the details of the My Prospects page (not shown) represented by block 870 under block 700c of FIG. 7A. FIG. 7A represents the algorithmic paths taken for the “My Prospects” page that is accessed after the user clicks tab 703 shown in FIG. 7. The first step of these paths shown in FIG. 7E, represented by “Type of professional” block 871, is to determine whether the professional is a mortgage broker/realtor or a non-conforming vendor. If the professional is a either a mortgage broker or a realtor, block 872 represents the path to determine whether the prospect is a realtor, a buyer/seller or a mortgage broker. The My Prospects page enables the user, e.g., a realtor, to view a list of buyer prospects and seller prospects on screens represented by “realtor prospect landing page” block 775, “view buyer prospects” 777 and “view seller prospects” 780 or to send a proposal to either the buyer or seller on screens represented by “send proposal” block 785. Before a realtor can send a proposal, a determination is made whether the realtor has paid the fee or not represented by “paid?” block 790.

FIG. 7F shows the flow chart for the details of the Professional Registration page 600 discussed above under block 795 in FIG. 7A. A series of algorithmic paths is undertaken by the system before the respective professional, e.g., realtor or mortgage broker, is deemed to be registered that is represented by blocks 796 and 797, respectively. The registered professional is then sent the list of prospect via the details block 870 under the “My Prospects” page represented by block 700c in FIG. 7A. A question of whether, for example, the realtor or mortgage broker has paid the necessary fee is referred to the professional registration from the My Prospects page represented by block 798 and 799, respectively.

FIG. 7G shows the flow chart for the details of the “edit profile” icon 207 under block 885 in FIG. 7A. A query to edit a user's profile can come up in a number of flow paths as shown in FIG. 7F. The user is determined to be either a buyer/seller or a professional as represented by block 886 is then sent to a “buyer/seller edit profile home page” represented by block 887 or “professional edit profile home page” block 888, respectively. As shown in FIG. 7G, a professional normally requires more information than a buyer/seller. The information includes as a photo represented by block 889, or a business history represented by block 890 in addition to the editing the professional's profile represented by block 891.

FIG. 7H shows the flow chart for the details of the My Tracker Wizard page 200b shown in FIG. 2B represented by block 891 under “transaction setup (Wizard)” block 892 in FIG. 7B. After the user initiates the tracking method by clicking on My Tracker wizard icon 205 shown on page 200a of FIG. 2A, the user is directed to Web page 200b represented by block 892. A series of paths are followed depending on the type of user as shown in FIG. 7H and as discussed in detail above in connection with FIG. 2B.

Tab 704 in FIG. 7 accesses the “Resource Center” page (not shown) that provides useful information to home buyers and encourages them to keep returning to the RealtyTracking.com Web site. This page links users to other real estate Web pages such as those found on “RealtyTimes.com.” This represented in FIG. 7A by block 700d.

A typical Web page referred to as My Tracker dashboard for the buyer and realtor is shown in FIG. 8. Web page 800 is the page the buyer, in this case Sara, is directed to after she clicks box 715 labeled “208 South Poinsettia Place” on page 700 of FIG. 7

FIG. 9 shows an example of message Web page 900 for the realtor. Table 905 has six columns having as the first column “Topics” column 910 that includes either a new post icon 912 or read post(s) icon 914 and a brief statement of the topic of the message for the realtor. “Replies” column 920 indicates the number of replies, if any, that have been provided for each of the message topics. “Author” column 930 shows the e-mail name used by the author of each of the messages. “Views” column 940 indicates the number of times that particular message has been seen by the various contacts. “Last Post” column 950 shows the date, time and e-mail name of the last posted message.

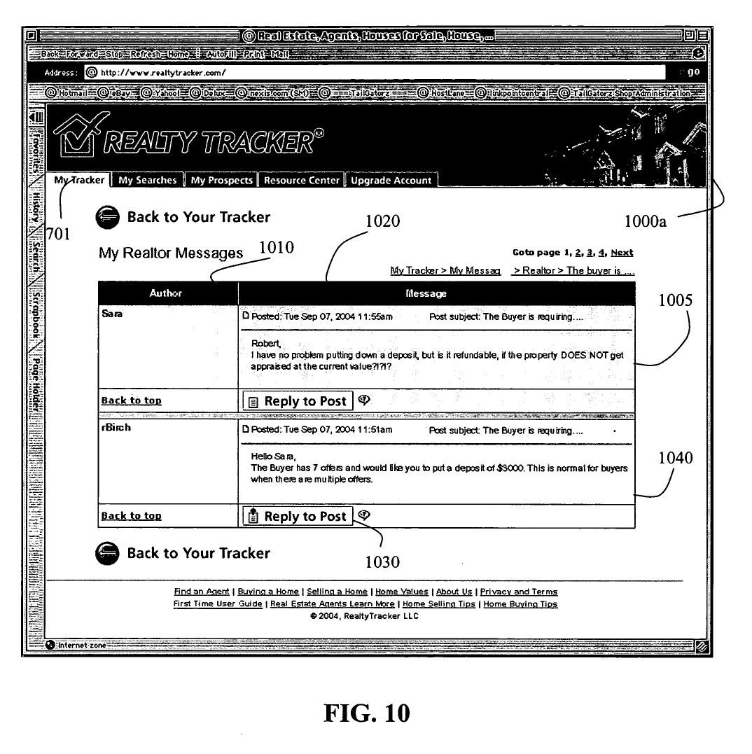

Web page 1000a of FIG. 10 is the page to which the realtor is directed when his mouse clicks on the underscored topic “The Buyer is Requiring a Deposit” under column 910 of FIG. 9. This is the topic that indicates 0 in the reply column 920 of FIG. 9 for that topic. Table 1005 contains “Author” column 1010 for the e-mail name of the one that posts the message and “Message” column 1020 that has space for the entire message, the date and time the message was posted, and subject of the posted message. Last Post column 950 in table 905 of FIG. 9 and Message column 1020 in table 1005 of FIG. 10 indicate that at 11:51 am rBirch sent a message to Sara, the buyer. Message column 1020 in table 1005 also indicates that Sara posted a reply at 11:55 am.

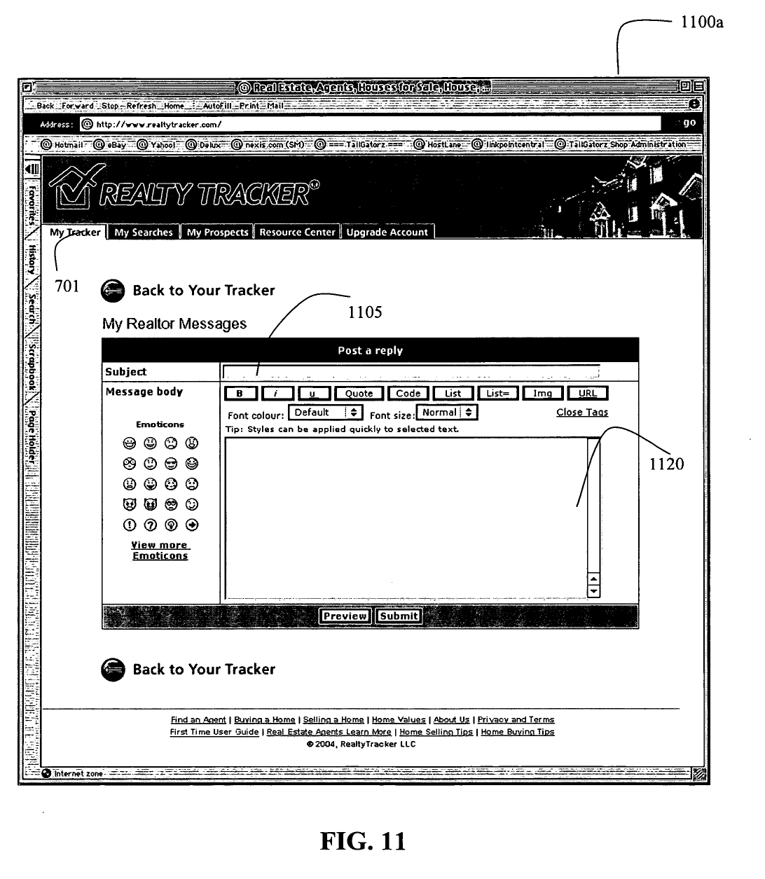

To post this message to Robert, Sara clicked on “Reply to Post” box 1030 that directs the realtor to Web page 1100a shown in FIG. 11. The realtor entered the subject the subject box 1105. The realtor inputted the message in space 1120 of page 1100a and is the message shown in box 1040 in table 1005 of FIG. 10. FIG. 11 is representative of the Web pages that the buyer, seller and the other vendors use to post messages and to reply to posted messages.

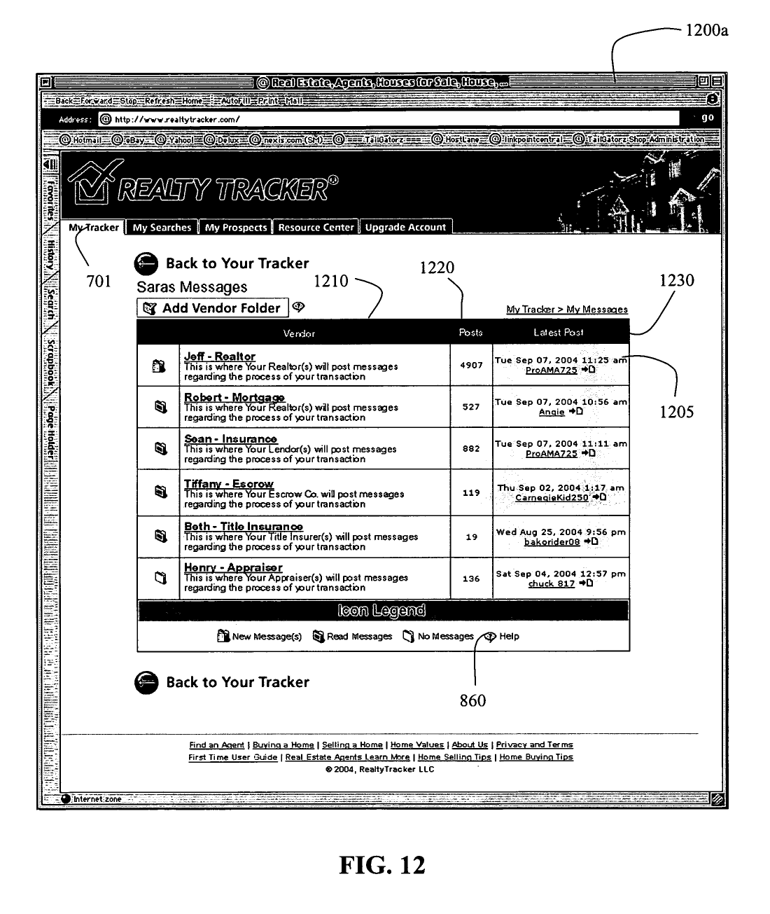

FIG. 12 shows Web page 1200a that contains buyer Sara's messages in table 1205 that has three columns. In “Vendor” column 1210, a scroll down list of all of the vendors involved in Sara's transaction are listed. “Posts” column 1220 indicates the total number of posted message between the buyer and the particular vendor in a given row of table 1205. In the typical case illustrated in FIG. 12, the overwhelming number of posted messages is between the buyer Sara and the realtor Jeff. “Latest Post” column 1230 gives the date, time and the e-mail name of the author of the last posted message.

Each time a vendor sends a message, the vendor can update their progress. The progress update of the present tracking system has the following features: (1) the vendor must send a message when updating their progress; (2) the vendor with one click of the mouse will be able to easily change the percentage of completion of the vendor's tasks; (3) all users must login to tracking Web site to see progress and messages; (4) all users have the ability to see when messages have been read or when recent updates have occurred as discussed above. Users are encouraged to conduct their real estate transactions with the present tracking system because of the use of such progress bars that provide instant updates and increase overall usage of the site.

Whenever a vendor updates their progress, they send an e-mail to every person in the transaction. For example, in connection with the transaction referred to above, the following is the type of e-mail notification that is sent to each contact:
Subject: 208 South Poinsettia Place Updated by Appraiser
Body: Dear Sean,
Bob the appraiser just left an update at RealtyTracker.com for the transaction at 208 South Poinsettia Place.
Click here to view this Update
Click Here to update your Status

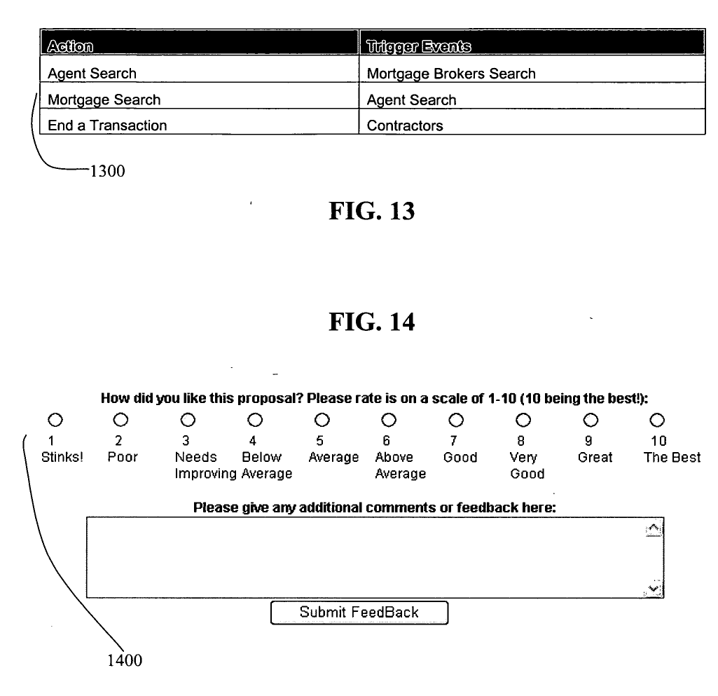

Table 1300 shown in FIG. 13 summarizes the actions that “trigger” an event resulting in campaign e-mail being sent to another vendor in the present tracking system and is made up of a column of actions and a column of trigger events. Campaign e-mails are part of the marketing promotion of the present system to encourage people who have never visited the Web site to come visit.

At the end of every transaction that occurs at the close of escrow, the buyer and sellers will have the ability to rate each of the vendor using chart 1400 shown in FIG. 14. The feedback provided by the information in the table will be used in the vendor's profile. Such feedback will create a check and balance for the vendors and ensure that future prospects have ample warning of any problems before choosing a vendor since chart 1400 is publicly available to all users viewing the tracking Web site.

FIG. 15 shows Web page 1500 used by a vendor to upgrade an account in one embodiment of the present real estate tracking system. A user clicks tab 705, the last tab on the tab system shown on FIG. 7, to link user to this “Upgrade Account” page. This page is primarily used by vendors to submit the necessary updated billing information in boxes 1501-1506 to be included in their respective files.

The preferred methods and systems of the present invention have the advantage of growing a large user base because vendors and buyers/sellers will invite other vendors and buyers/sellers into the system that not otherwise have used it and thus having a multiplicity effect. The tracking system encourages users to add specific vendors and prospects that would not have otherwise used the system. The process and system of the present invention is not to be limited in scope by the specific embodiments described herein. Various modifications of the invention in addition to those described herein will become apparent to those skilled in the art from the foregoing description and the accompanying figures. Such modifications are intended to fall within the scope of the appended claims.

What is claimed is:

1. A method for tracking real estate transactions via a computerized and interconnected communications network comprising the following steps:
(a) receiving and storing in a computerized database initial data inputs from a plurality of contacts including buyers, sellers, real estate agents and other vendors relating to each of a plurality of identifiable pieces of real estate;
(b) establishing a separate database file for each of the identifiable pieces of real estate of a given real estate transaction;
(c) organizing each of the files of step (b) according to each contact of the real estate transaction;
(d) receiving and storing information from each of the contacts in the database file after at least one task is completed of the number of predetermined tasks required to be completed by each of the contacts to complete the real estate transaction;
(e) calculating the contact progress of each of the contacts as a percentage by dividing the number of tasks completed by each of the separate contacts at any given time during the transaction by the total number of tasks required to be completed by that contact multiplied by 100 and representing the result as a contact progress bar; and
(f) communicating to each of the contacts the resulting contact progress bar during the transaction.

2. The method of claim 1, wherein a buyer/seller progress is calculated as a percentage by dividing the sum of all of the contact progress of the total number of contacts divided by the total number of contacts in the transaction, the buyer/seller progress is graphically represented as a buyer/seller progress bar, and the buyer/seller progress bar is communicated to the contacts involved in the transaction.

3. The method of claim 1, wherein the given real estate transaction is started when a contact requests a search be made in connection with said piece of real estate and wherein a trigger event occurs at the start of the transaction.

4. The method of claim 3, wherein a prospect selected from the group consisting of a buyer, a seller, and a combination thereof requests to search for a realtor is an action that results in the trigger event of a search for a mortgage broker to join the transaction.

5. The method of claim 3, wherein the trigger event at the start of a transaction by the prospect is a search for other vendors to join in the transaction.

6. The method of claim 5, wherein the other vendors are selected from the group consisting of an escrow company, an insurance agent, a title insurance company, an appraiser, and a combination thereof.

7. The method of claim 3, wherein the end of the transaction occurs at the close of escrow.

8. The method of claim 7, wherein the trigger event at the end of the transaction is a search for contractors.

9. The method of claim 3, wherein any user of the tracking method may view the transaction without obligation via the interconnected communication network to request an invitation to enter into the transaction.

10. The method of claim 9, wherein the user requesting the invitation is a vendor offering services to the contacts involved in the transaction.

11. The method of claim 10, wherein the vendor is under an obligation to pay a monthly fee after accepting the invitation to enter into the transaction.

12. The method of claim 2, wherein a buyer or seller may submit an invitation to any vendor to enter into the transaction.

13. The method of claim 2, wherein any vendor may offer services to the contacts involved in the transaction

14. The method of claim 13, wherein more than one vendor has the option of offering the same services of vendors that have joined in the transaction.

15. The method of claim 7, wherein buyers and sellers are given the opportunity to rate the vendors at the end of the transaction.

16. The method of claim 1, wherein an e-mail message is sent to all contacts in the transaction after a task has been completed by any of the contacts that are included in the calculation of the contact progress.

17. A method for tracking real estate transactions via a computerized and interconnected communications network comprising the following steps:
(a) receiving and storing in a computerized database initial data inputs from a plurality of contacts including agents, buyers, sellers, and vendors relating to each of a plurality of identifiable pieces of real estate;
(b) establishing a separate database file for each identifiable piece of real estate at the start of a real estate transaction that occurs when a contact requests a search in connection with said piece of real estate;
(c) organizing each of the database files of step (b) according to each contact of the real estate transaction;
(d) receiving and storing information from each of the contacts in the database file after at least one task is completed of the number of predetermined tasks required to be completed by each of the contacts to complete the real estate transaction;
(e) calculating the contact progress of each of the contacts as a percentage based on the following representational equation for the first contact:
$${PC}_{1} = \frac{{x}_{1}}{{n}_{1}} ( 100 )$$
where:
x₁=the number of tasks completed by a first contact at any given time during the transaction, and
n₁=the number of predetermined tasks required to be completed by the first contact;
(f) communicating to each of the contacts a contact progress bar during the transaction for each of the contacts that graphically represents the contact progress of each of the contacts calculated from step (e);
(g) determining the total number of contacts, “y,” involved in the real estate transaction;
(h) calculating the buyer/seller progress, “PB/S” as an average of all of the other progress bars based on the following equation:
$$PB / S = \frac{\sum ( {PC}_{1} … PCy )}{y} ; and$$
where:
y=the total number of contacts to a given transaction; and
PCy=the percentage of the tasks completed by the y^{th} contact to the transaction; and
(i) communicating to each of the contacts involved in the transaction a buyer/seller progress bar that graphically represents the contact progress of the buyer and seller calculated from step (h).

18. The method of claim 17, wherein a trigger event occurs at the start of the transaction.

19. The method of claim 18, wherein a prospect selected from the group consisting of a buyer, a seller, and a combination thereof requests to search for a realtor is an action that results in the trigger event of a search for a mortgage broker to join the transaction.

20. The method of claim 18, wherein the trigger event at the start of a transaction by the prospect is a search for other vendors to join in the transaction.

21. The method of claim 18, wherein the end of the transaction occurs at the close of escrow.

22. The method of claim 21, wherein the trigger event at the end of the transaction is a search for contractors.

23. The method of claim 17, wherein the number of users grows based on the invite of additional vendors into the transaction by the contacts of the transaction.

24. The method of claim 17, wherein buyers and sellers are given the opportunity to rate the vendors at the end of the transaction.

25. The method of claim 17, wherein an e-mail message is sent to all contacts in the transaction after a task has been completed by any of the contacts that are included in the calculation of the contact progress.

26. A system for tracking real estate transactions via a computerized and interconnected communications network comprising;
(a) means for receiving and storing data inputs from a plurality of contacts including agents, buyers, sellers, and vendors relating to each of a plurality of identifiable pieces of real estate;
(b) means for establishing a separate database file for each identifiable piece of real estate of a given real estate transaction;
(c) means for organizing the data into separate files for each of the contacts of a given real estate transaction;
(d) means for receiving and storing information from each of the contacts in the database file after at least one task is completed of the number of predetermined steps required by each of the contacts to complete the real estate transaction;
(e) means for calculating the contact progress for each of the contacts as a percentage by dividing the number of tasks completed by each of the separate contacts at any given time during the transaction by the total number of tasks required to be completed by that contact and for calculating buyer/seller progress bar by taking an average of the contact progress of the total number of contacts involved in the transaction; and
(f) means for communicating a graphical representation of the contact progress bar to all contacts and the buyer/seller contact progress bar to all contacts involved in the transaction.
